(19) United States
(12) Patent Application Publication
(10) Pub. No.: US 2008/0254343 A1
(43) Pub. Date: Oct. 16, 2008

(54) Electrochemical cell with thermal current interrupting switch

(75) Inventors: David A. Kaplin, Mayfield Heights, OH (US); James X. Wu, North Olmsted, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 11/787,436

(22) Filed: Apr. 16, 2007

(51) Int. Cl. H01M 6/50; H01M 2/12

(52) U.S. Cl. 429/53; 429/61

(57) ABSTRACT

An electrochemical cell having a current interrupting switch as an internal component of the cell that is thermally responsive and breaks an electrical path within the cell thereby preventing current flow when temperature within the cell is at or above an activating temperature. The switch is reversible and current flow and a closed circuit is re-established when temperature within the cell returns below the activating temperature.

### FIELD OF THE INVENTION

The present invention relates to an electrochemical cell having a current interrupting switch as an internal component of the cell that is thermally responsive and breaks an electrical circuit or path within the cell, thereby preventing current flow when temperature within the cell and thus a switch member is at or above an activating temperature. The switch is reversible whereby current flow and a closed circuit are re-established when temperature of the switch member and within the cell returns below the activating temperature.

### BACKGROUND OF THE INVENTION

Electrochemical cells such as batteries are used to generate electrical energy to operate electronic devices. When batteries are misused or otherwise subjected to abusive conditions, the energy they are capable of producing can create potentially dangerous conditions. For example, exposure to high temperatures can create high internal pressures, and if the internal pressure becomes too great, the battery housing can be forced open, and housing and internal components can be forcefully ejected and can cause damage to a device which is powered by the cell or to the surrounding environment. A cell with a relatively low melting point metal, such as a lithium battery, can also be heated sufficiently to melt that metal, causing an internal short circuit and runaway exothermic reactions. Exposure to abnormal or abusive electrical conditions can also generate a large amount of heat, thereby increasing the risk of fire in the event the cell is located proximate to any combustible material(s).

To prevent rupturing of the cell container and forceful ejection of cell components, batteries often have pressure relief mechanisms, or vents, that will open to relieve the internal pressure at a lower level. However, this does not necessarily prevent the release of potentially dangerous fluids (e.g., corrosive electrolytes) or prevent the continued generation of heat within the cells. An example of a battery with a pressure relief vent in the cell container is disclosed in U.S. Patent Publication No. 2004/0157115 A1 and U.S. Pat. Nos. 6,348,281, 6,346,342 and 4,803,136, all incorporated herein by reference.

To prevent unwanted and/or unnecessary venting of cells, fuses have been incorporated into some batteries, particularly higher energy batteries (e.g., rechargeable alkaline batteries such as nickel/cadmium batteries, primary and rechargeable lithium batteries with a variety of active positive electrode materials, and rechargeable lithium ion batteries). However, fuses that permanently break the electrical circuit do not allow the battery to be used once the abusive condition has been removed, even if the battery has not been damaged. Examples of batteries with fuses also incorporated into the cells are disclosed in U.S. Pat. Nos. 4,879,187 and 4,188,460, which are incorporated herein by reference.

As an alternative to a fuse, other types of current interrupters have been used. Some of these respond to internal pressure and some respond to heat. The thermally responsive current interrupters can make use of bimetallic or shape memory alloy components that change shape when their temperatures exceed predetermined values, and some also incorporate a diode, such as a Zener, Schottky, or power rectifier diode, to generate additional heat if the current flow exceeds a desired maximum. Some current interrupters permanently break the electrical circuit, while some are reversible. Examples of batteries with such current interrupters are disclosed in the following U.S. Pat. Nos. , all of which are incorporated herein by reference. 6,570,749; 6,342,826; 6,084,501; 6,037,071; 5,998,051; 5,766,793; 5,766,790 and 5,747,187. Additional examples are also disclosed in Unexamined Japanese Patent Publication Nos. 05-205727, 08-236102, 10-154530, 10-261400, 59-191273, 2003-288876 and 2004-103250. The batteries disclosed in these references have one or more disadvantages. They may require a large number of components or have complicated structures, adding to the battery cost, complicating the manufacturing process, and often increasing the internal resistance, thereby adversely affecting battery performance, particularly under heavy discharge conditions (e.g., low resistance, high current and high power). Some do not include a pressure relief vent, so a separate vent is required. In some, the operation of the current interrupter can coincide with the operation of the pressure relief vent, so breaking the internal circuit does not serve to prevent venting of potential harmful fluids.

Some batteries have used positive temperature coefficient (PTC) devices, either instead of or in combination with a fuse or reversible circuit breaking device. When the flow of current exceeds a threshold limit in a PTC device, or the PTC device otherwise exceeds a threshold temperature, the resistance of the PTC device increases rapidly to reduce the flow of current to a very low level. This provides protection against electrical abuses such as external short circuits, overcharging and forced discharge. However, it does not completely break the electrical circuit between the positive and negative electrodes. The addition of a PTC device to a battery also has disadvantages similar to those of reversible circuit interrupters: increased cost, manufacturing complexity, and internal resistance.

Examples of Li/FeS₂ cells each having a pressure relief vent, a PTC device and a thermally responsive shape memory alloy current interrupter are disclosed in U.S. Pat. Nos. 4,975,341 and 4,855,195, both of which are incorporated herein by reference. Disadvantages of cells containing PTC devices can include increasing cell internal resistance with increasing temperature before operation of the PTC, an increase in internal resistance after the PTC initially operates and then resets (returns to a “normal” resistance), and excessive time for the PTC to cool and reset after the heating source is removed.

### SUMMARY OF THE INVENTION

In view of this background, it is an object of the present invention to provide an electrochemical cell, preferably a primary lithium/iron disulfide cell, including an internal current interrupting switch that is thermally activated and can open an electrical circuit between one of the electrodes of the cell and a cell terminal, and thereby aid in preventing temperature or pressure levels, or both, within the cell from rising above a desired or predetermined level.

It is a further object of the present invention to provide an electrochemical cell having a current interrupting switch that includes a bimetal material or a shape memory alloy or both, that is reversible, allowing a closed circuit to be re-established after temperature within the cell returns below an activating temperature.

Still another object of the present invention is to provide an electrochemical cell including an internal seal plate located in a cell container between the electrolyte, electrode assembly and the current interrupting switch which substantially reduces electrolyte leakage from the cell.

A further object of the present invention is to provide increased cell capacity when compared to a conventional cell by reducing volume taken up by the end assembly including the current interrupting switch.

Another object of the present invention is to provide an electrochemical cell having an end assembly including a current interrupting switch operatively connected to a conductive terminal of a terminal cap wherein the terminal cap is sealed over the outside surface of the container.

One of the final objects of the invention is to provide a “drop-in” alternative to fuses, PTC's or other current interrupting devices currently used in lithium/iron disulfide batteries. This alternative allows for the effective and controllably intermittent disruption of current flow to prevent overheating, venting or other undesirable conditions that may occur to an electrochemical cell and possesses the same or similar physical dimensions and operating parameters as these previous devices, so as to be a fungible replacement for currently used devices, such as a PTC.

In one aspect of the invention, an electrochemical cell is disclosed, comprising a container having a closed end and an open end; an electrode assembly disposed within the container and including a negative electrode, a positive electrode, an electrolyte, and a separator disposed between the negative electrode and positive electrode, wherein one of the electrodes is electrically connected to the container; an internal seal plate located inside the container and providing a seal between the open end of the container and the electrode assembly, the seal plate being in contact with the container and being electrically non-conductive or having a polarity the same as the container; an electrically conductive contact member extending through the seal plate; and an end assembly covering the seal plate and having a terminal cap with a conductive terminal, wherein the contact member provides a portion of an electrical path between the electrode not electrically connected to the container and the terminal, wherein an insulating gasket is present between the seal plate and the contact member when the seal plate is the same polarity as the container, wherein a temperature responsive current interrupting switch is present in the end assembly and operatively connected between the contact member and the terminal so that below an activating temperature the current interrupting switch is at least part of an electrical path between the contact member and the terminal, and at or above the activating temperature the current interrupting switch is out of electrical contact with one or more of the contact member and terminal, and a circuit between the contact member and terminal is opened, and wherein the current interrupting switch is capable of re-establishing a closed circuit between the contact member and terminal when the temperature in the cell is below the activating temperature.

Another aspect of the invention is an electrochemical cell, comprising a container having a closed end and an open end; an electrode assembly disposed within the container and including a negative electrode, a positive electrode, an electrolyte, and a separator disposed between the negative electrode and positive electrode, wherein one of the electrodes is electrically connected to the container; and an end assembly sealing the open end of the container and having a terminal cap with a conductive terminal, and a temperature responsive current interrupting switch operatively connected between the conductive terminal and the electrode of the electrode assembly not electrically connected to the container so that below an activating temperature the current interrupting switch is part of an electrical path between the terminal and the electrode not electrically connected to the container, and at or above the activating temperature the current interrupting switch is switched and the electrical path is interrupted, wherein the current interrupting switch is capable of re-establishing the electrical path when the temperature in the cell is below the activating temperature, wherein an insulating gasket is provided between the terminal cap and the open end of the container, and wherein the terminal cap extends over the open end of the container and has a perimeter that terminates outside of the container and seals the open end.

Yet another aspect of the invention is an electrochemical cell, comprising a cylindrical container having a closed end and an open end; a jelly-roll electrode assembly disposed within the container and including a negative electrode, a positive electrode, an electrolyte, and a separator disposed between the negative electrode and positive electrode, wherein one of the electrodes is electrically connected to the container; an end assembly having a conductive terminal and a non-articulating temperature-responsive switch, wherein the switch changes shape to selectively control current flow between the electrode not electrically connected to the container and the conductive terminal based upon a pre-determined temperature; and an internal seal plate and optionally a gasket providing a seal between the open end of the container and the electrode assembly, and wherein the switch is operatively located between the conductive terminal and the seal member within the cell.

The present invention achieves these and other objectives which will become apparent from the description that follows.

Unless otherwise specified herein, all disclosed characteristics and ranges are as determined at room temperature (20-25° C.).

### BRIEF DESCRIPTION OF THE DRAWINGS

The invention will be better understood and other features and advantages will become apparent by reading the detailed description of the invention, taken together with the drawings, wherein:

FIG. 1 is a partial cross-sectional elevational view of a portion of an electrochemical cell including one embodiment of a current interrupting switch;

FIG. 2 is a partial cross-sectional elevational view of a portion of an electrochemical cell including a further embodiment of a current interrupting switch;

FIG. 3 is a partial cross-sectional elevational view of a portion of an electrochemical cell including a further embodiment of a current interrupting switch, and wherein a sealing plate of the cell is shown including a vent assembly;

FIG. 4 is a partial cross-sectional elevational view of a portion of an electrochemical cell including a further embodiment of a current interrupting switch;

FIG. 5 is a partial cross-sectional elevational view of a portion of an electrochemical cell including another embodiment of a current interrupting switch;

FIG. 6 is a partial cross-sectional elevational view of a portion of an electrochemical cell including a further embodiment of a current interrupting switch, wherein the cell is closed by the terminal cover extending over the outer open end of the container;

FIG. 7 is a top view of the switch member of the current interrupting switch shown in FIG. 6;

FIG. 8 is a partial cross-sectional elevational view of a portion of an electrochemical cell showing an alternative embodiment of a current interrupting switch; and

FIG. 9 is a partial cross-sectional elevational view of a portion of an electrochemical cell including a further embodiment of a current interrupting switch.

### DETAILED DESCRIPTION OF THE INVENTION

Electrochemical cells of the present invention include a current interrupting switch located within the cell casing which can include a container closed by an end assembly including a terminal cap with the switch being temperature responsive and part of an internal closed circuit or electrical path within the cell below an activating temperature and wherein at or above the activating temperature, the current interrupting switch is moved to an open position thereby opening, breaking, or otherwise interrupting the internal closed circuit or path within the cell thereby preventing current flow. The current interrupting switch is preferably capable of re-establishing the closed circuit or electrical path internally when the temperature in the cell and a switch member of the switch is below the activating temperature. In a preferred embodiment, the cell is a primary cylindrical Li/FeS₂ AA or AAA cell (i.e., according to IEC nomenclature, FR06 and FR03, respectively speaking), such as described in connection with the drawings hereinbelow. Active material systems such as lithium/iron disulfide can experience significant volumetric expansion upon discharge. To the extent that the positive electrode comprising iron disulfide is coated on a carrier such as a current collector and assembled with a negative electrode and separator in a jelly-roll configuration, the effects of radial expansion are exacerbated. Thus, cylindrical containers are preferred over straight-walled prismatic cells as the cylindrical containers possess higher hoop strength and are better able to withstand the pressures generated during discharge. It is an additional challenge to develop a current interrupting switch internal to the cell for a cylindrical cell including a jelly-roll electrode assembly, especially wherein the switch is to be connected between current collectors of an electrode of the jelly-roll and a cell terminal. However, as will be recognized by those of ordinary skill in the art, the disclosure is applicable to various cylindrical cell sizes (R06, R03, etc.) and other chemical systems (e.g., lithium-ion, nickel-metal hydride, lithium/manganese dioxide, LiCFₓ, etc.)

Referring now to the drawings, FIG. 1 illustrates a portion of cell 10, such as an FR6 type battery cell, which has a can or container 12 with a closed bottom end and an open top 14 closed by an end assembly having a terminal cap 22 with a conductive terminal 24, which is the entire cap as illustrated in FIG. 1. An insulating gasket 16 is disposed between terminal cap 22 and container 12 to prevent short circuiting when the terminal cap 22 includes an electrically conductive portion such as the perimeter or periphery that would otherwise come in contact with the container 12.

Situated in container 12 is an electrode assembly 30 which can be of a type such as, but not limited to, stacked, plated and spirally wound, with a spirally wound or jelly-roll type electrode assembly 30 preferred as illustrated in FIG. 1. Spiral-wound electrodes, as known in the art, are generally electrode strips that are combined into an assembly by winding along their lengths or widths, for example around a mandrel or central core. The electrode assembly includes a positive electrode 32, a negative electrode 36 and a separator 38, which is preferably a thin microporous membrane that is ion-permeable and electrically non-conductive disposed between adjacent surfaces of the positive electrode number and negative electrode to electrically insulate the electrodes from each other. Portions of the separator may also insulate other components in electrical contact with the cell terminals to prevent internal short circuits. Edges of the separator often extend beyond the edges of at least one electrode to insure that the negative electrode and positive electrode do not make electrical contact even if they are not perfectly aligned with each other. However, it is desirable to minimize the amount of separator extending beyond the electrodes. The positive electrode 32 includes a current collector 34 preferably metal, that extends from the top of the electrode assembly and is electrically connected to a contact spring 40 and/or contact member 42. An insulating member 31, such as an insulating cone, formed of any suitable insulating material, can be disposed between contact spring 40 and the container sidewall to prevent an internal short circuit. The negative electrode 36 is electrically connected to the inner surface of container 12, preferably by a metal tab (not shown) in one embodiment. Contact between positive electrode 32 and the bottom of container 12 can be prevented by the inward folded extension of separator 38 and/or an electrically insulating disk which can be positioned in the bottom of container 12.

Cell 10 includes an internal seal plate 44 which forms a seal between the electrode assembly 30 and electrolyte in the lower portion of the container 12 and the end assembly 20 in the upper portion of the can with the end assembly 20 covering the seal plate 44 within the cell 10. In one embodiment, a seal plate is metal or another electrically conductive material such as, but not limited to, steel such as nickel plated steel and stainless steel. The seal plate 44 is supported by a bead or a step in the can, which if seal plate 44 is the same polarity as the container 12 can be connected to the inner surface of container 12, for example preferably by welding, such as laser welding after the desired components have been placed in the lower portion of container 12. Thus, the seal plate 44 is the same polarity as the container in one embodiment, and the welded or other seal, such as gasket 16, is established between the end assembly 20 and substantially eliminates or reduces electrolyte leakage between the electrode compartment and the remainder of the cell above the seal plate 44 as shown in FIG. 1. In the case where the seal plate 44 is electrically conductive and connected to container 12, an insulating gasket 46 is provided between contact member 42 and seal plate 44 which are of different polarity. Seal plate 44 can include a flange, rim, projection, collar, or the like, in order to, for example, provide a desirable seal to gasket 46.

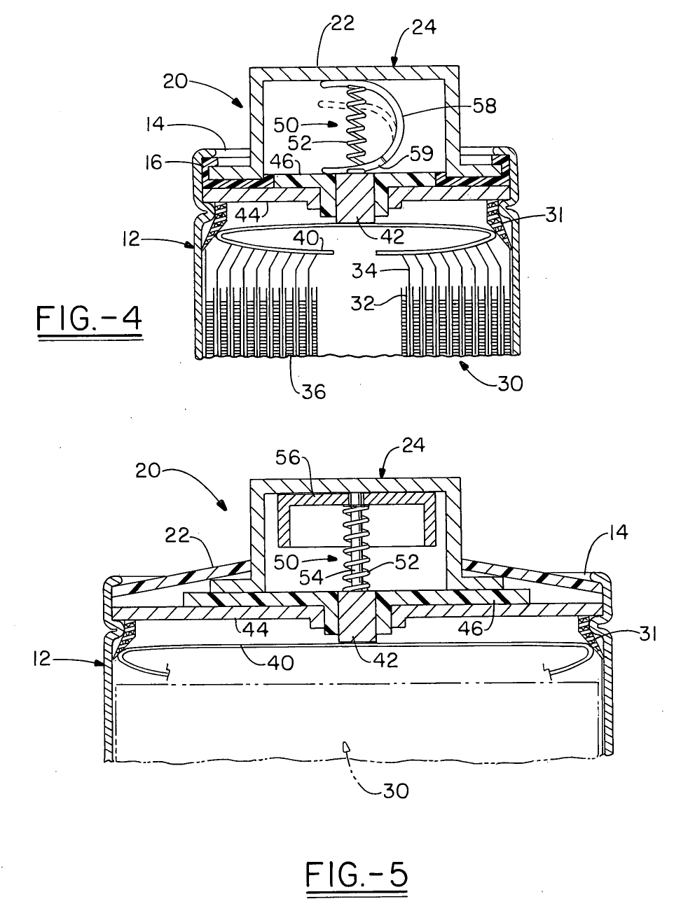

In a further embodiment, seal plate 44 is constructed of a material which is sealed or electronically isolated about its peripheral portion to the inner wall of container 12, such as through adhesive or with a gasket (not shown). Suitable non-conductive materials include polyolefins such as polyethylene and polypropylene. When seal plate 44 is electronically isolated from container 12, gasket 46 may be integrated therewith, or seal plate 44 may extend to directly contact and provide a seal between contact member 42 and seal plate 44. As illustrated in FIG. 3, seal plate 44 can include a pressure relief vent 48, for example as known to those of ordinary skill in the art, such as a ball vent, an aperture closed by a rupture membrane, such as disclosed in U.S. Patent Publication No. 2005/0244706 A1, incorporated herein by reference, or a thin area such as a coined groove, that can tear or otherwise break, to form a vent aperture in sealing plate 44. In other embodiments, a pressure relief vent can be included in another portion of container 12, such as bottom end thereof.

Contact member 42 is preferably a rod in one embodiment, and is formed of a conductive material, preferably metal, extending through seal plate 44 thereby providing a portion of a conductive path between the positive electrode 32 and the conductive terminal 24 of cell 10. Contact member 42 is preferably compression fit in gasket 46, but can be otherwise fixed, such as through an adhesive or the like.

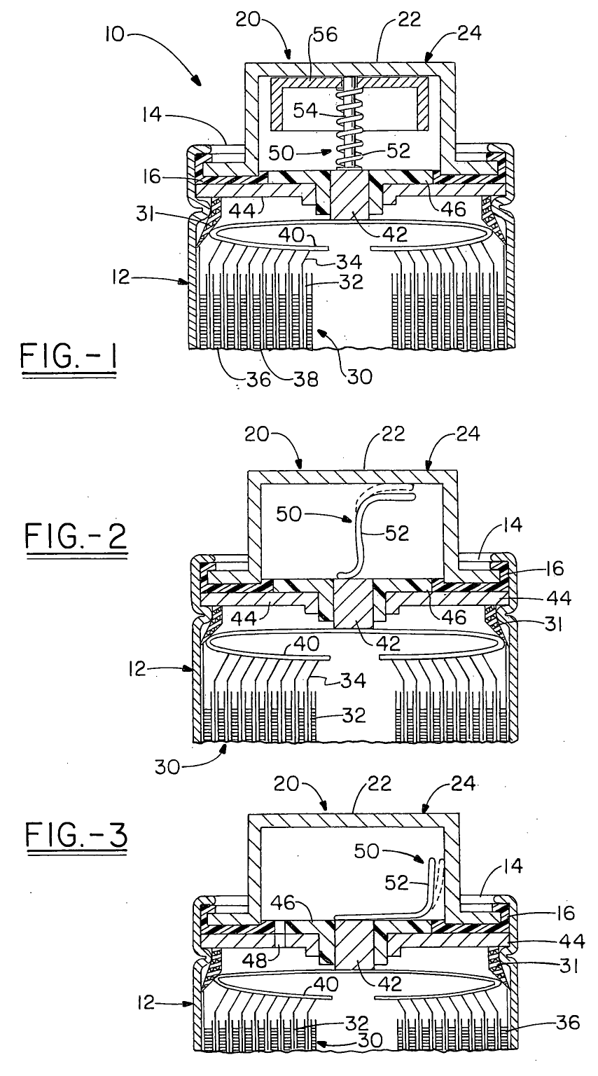

A current interrupting switch 50 is disposed in the electrical path between positive electrode 32 and conductive terminal 24. As shown in FIG. 1, the current interrupting switch 50 includes a switch member 52 formed of a material that, upon heating above an activating temperature, will deform in such a way as to break electrical contact preferably with one or more of a conductive part of the terminal cap 22 and the contact member 42, such as shown in FIGS. 2, 3, 4 and 6, and thereby open a circuit in the electrical path between the positive electrode 32 and conductive terminal 24, preventing current from flowing therebetween. The activating temperature is preferably selected to be less than a temperature at which the internal cell pressure would cause the pressure relief vent to open. In this way, if the cell is subjected to an abnormal or abusive electrical condition that cause internal heating within the cell, such as an external short circuit, abnormal charging, or forced deep discharge, the electrical circuit can be broken to stop the heat generation and pressure rise before the cell vent opens. If the switch member 52 is made from a material that will return its normal shape after cooling below the activating temperature, it may also be possible to continue normal use of the cell if the abnormal condition is removed or further prevented.

If the cell 10 includes a PTC, the activating temperature at or above which the switch member 52 would deform is preferably greater than the temperature at which the resistance begins to increase significantly. Including a PTC provides an additional current limiting feature. However, since the current interrupting switch assembly 50 of the invention can completely break electrical contact between positive electrode 32 and conductive terminal 24, the additional complexity and cost of including a PTC may not be necessary.

As the switch member 52 is part of the electrical connection between a positive electrode number and the conductive terminal 24, it is made from a material with good electrical conductivity. In order to break the electrical connection, the material is also one that causes the switch member 52 to deform when its temperature is at or above the activating temperature as a result of either exposure to heat from another source, either inside or outside the cell, or both, or excessive I²R heating from an abnormally high rate of current flow through the switch member 52. Switch member 52 is formed from a suitable material such as a shape memory alloy or a bimetal, or a combination thereof.

A shape memory alloy is an alloy that can be deformed at one temperature but when heated or cooled returns to its previous shape. This property results from a solid phase transformation, between the Martensite and Ausenite phases. Preferred shape memory alloys have a two-way shape memory, i.e., the transformation is reversible, upon both heating and cooling. Examples of shape memory alloys include, but are not limited to, nickel-titanium, copper-zinc-aluminum and copper-aluminum-nickel alloys, with nickel-titanium being preferred. Manufacturers of nickel-titanium and other shape memory alloys include Specialty Metals, Shaped Memory Alloy Division of New Hartford, N.Y., USA, Memry Corporation of Bethel, Conn., USA, and Dynalloy, Inc. of Mesa, Calif., USA.

A bimetal is a material with at least two layers of dissimilar metals having different coefficients of thermal expansion. An example is a material with a layer of a nickel-chromium-iron alloy having a high coefficient of thermal expansion and a layer of a nickel-iron alloy having a lower coefficient of thermal expansion. Manufacturers of bimetallic switches include Sensata Technologies B.V. of Attleboro, Mass., USA; Madison Company of Branford, Conn., USA; Therm-o-Disc, a Subsidiary of Emerson, of Mansfield, Ohio, USA; and Otter Control Limited of Derbyshire, England.

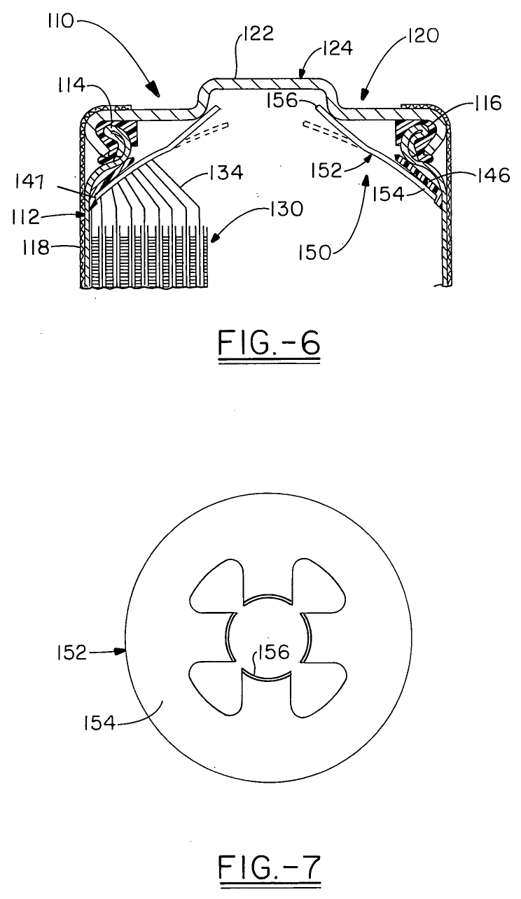

Switch member 52 material is preferably selected to deform upon heating above a maximum normal temperature, i.e., at and above the activating temperature, and also is chosen to have a relatively low electrical resistance, at least below the activating temperature. The switch member 52 is non-articulating and thus does not contain jointed connections or hinges in order to provide the current interrupting feature of the switch. If the switch member 52 is in contact or exposed to fluids contained within the cell, such as electrolyte, for example as shown in FIG. 6, the material selected is preferably stable in the presence thereof. Alternatively, the switch member 52 or other portions of the current interrupting switch assembly 50 can be coated with a material that is stable in the internal cell environment to provide the desired stability. The coating can be any suitable material, applied by any suitable process, that adequately protects the exposed surfaces of assembly 50 or switch member 52 without introducing an unacceptably high resistance into the electrical circuit between the positive electrode 32 and conductive terminal 24. In a preferred embodiment of the invention, the material selected for switch member 52 results in a rapid deformation of switch member 52 when it reaches or exceeds the activating temperature, and preferably it allows return to its normal shape after cooling below the activating temperature thereby re-establishing a closed circuit.

For a cell with good electrical and good high current and high power discharge characteristics, it is desirable for the switch member 52 to have a relatively low resistance. Preferably the switch member 52 resistance will be no greater than about 0.04 ohm, and more preferably no greater than about 0.03 ohm at room temperature. The resistance of the switch member 52 may increase or decrease with increasing temperature as desired; preferably the resistance will be no more than about 100 percent higher, and more preferably no more than about 60 percent higher, at the deformation temperature than at room temperature. The switch member 52 resistance can be measured by measuring the voltage drop across the member when a constant current is applied. For example, a switch member can be put into an electrically conductive fixture having a shape, dimensions and spacing to simulate the cover assembly components with which the switch member 52 will contact in the cell. One set of leads (current carrying and voltage sensing) can be welded to the top of the fixture, and another set can be welded to the bottom of the fixture. A constant current that will not cause significant heating of the switch member (e.g., 0.1 amp) is applied through the current carrying leads using a power supply, and the voltage drop is measured using a multimeter connected to the voltage sensing leads.

As indicated herein, the switch member 52 is designed to deform at a temperature that will not produce a high internal cell pressure to open the cell vent, but not at a normal storage or operating temperature. In view thereof, switch member 52 deforms sufficiently to break or open the circuit between the positive electrode and the conductive terminal 24 at an activating or predetermined temperature generally between about 70° C. and about 110° C., desirably between about 80° C. and about 100° C., and preferably between about 85° C. to about 100° C. If the switch member 52 deforms at too low of a temperature, use of the cell will be unnecessarily interrupted. If the switch member 52 deforms at too high of a temperature, the cell vent can rupture or a fire in the cell can occur.

Initial deformation time can be measured when the switch member 52 is subjected to a constant current. For cells used in consumer-replaceable primary batteries, the initial deformation time, i.e., the time from the initial application of the test current until the switch member deforms sufficiently to break the circuit between the electrode and the conductive terminal, is preferably no longer than about 1.0 second, more preferably no longer than about 0.75 second, when tested at a constant current of 10 amps. The initial and subsequent deformation times can be measured using the resistance test fixture described above. A power supply is connected to the current carrying leads, with a 0.1 ohm resistor in series, and a data logger (e.g., an AGILENT® 34970A Acquisition/Switch Unit), with the acquisition rate set to no longer than 0.1 second per point, is connected across the 0.1 ohm resistor to measure the current across the resistor. A 10 amp constant current is applied shortly after the data logger is switched on. The initial deformation time is the duration of time from initial application of the current until the current across the resistor drops to essentially zero. The reset times (time for the sealing plate to cool and return to its normal shape, thereby re-establishing the circuit) and subsequent deformation times can also be determined by continuing the test. It is desirable that the average current over time be less than a critical value, which can be established for each cell type, to prevent overheating, which could lead to cell venting, for example.

According to the present invention, current interrupting switch 50 can have a number of different forms. Current interrupting switch 50 in FIG. 1 includes non-conductive or dielectric guide member 54, shaped such as a rod, bar, or pin, preferably extending and connected between contact member 42 and terminal cap 22 and through cover contact 56 which is conductive and part of conductive terminal 24. In the embodiment illustrated in FIG. 1, switch member 52 is formed as a spring that is positioned over or around guide member 54 which extends therethrough. Below the activating temperature as illustrated in FIG. 1, switch member 52 is in electrical contact with cover contact 56 and contact member 42, whereby current is allowed to flow therethrough. Guide member 54 directs switch member 52 and prevents the switch member from diverting from a chosen travel path and prevents unwanted contact with other components of the cell. At or above the activating temperature, the switch member 52 deforms preferably by retracting or coiling upward or downward depending on which end is fastened and breaks a circuit between contact member 42 and cover contact 56. Preferably one end of switch member 52 is connected such as by welding to either the contact member 42 or cover contact 56. When the temperature of switch member 52 decreases below the activating temperature, contact in a closed electrical circuit is re-established between cover contact 56 and contact member 42.

FIGS. 2 and 3 illustrate additional forms of current interrupting switches 50. In the embodiment of FIG. 2, switch member 52 is a blade or strip-like piece connected to contact member 42 by riveting, welding, or another suitable fixing method. The distal end of switch member 52 opposite the connection is in contact (dashed lines) with the underside of conductive terminal 24 of terminal cap 22 when temperature of the switch member 52 is below the activating temperature. At or above the activation temperature, the switch member 52 deforms and moves out of contact with conductive terminal 24 shown by the solid lines present in FIG. 2. FIG. 3 illustrates a switch member 52, wherein contact (dashed lines) to a side of the conductive terminal 24 is made by a distal end of switch member 52 below the activating temperature. A deformation position is also illustrated.

A further embodiment of a current interrupting switch 50 is illustrated in FIG. 4. Therein, switch member 52 which is shaped as a spring is connected to contact member 42 such as by welding, riveting, or other suitable fastening device. Lead 58 which can optionally include a non-conductive segment 59 is operatively connected to contact member 42 or gasket 46 or both. Lead 58 can also be attached to seal plate 44 if seal plate 44 is electronically isolated from container 12. An upper portion of lead 58 is connected to an upper portion of the heat deformable switch member 52 and also in contact with conductive terminal 24 when temperature within the cell and switch member 52 is below the activating temperature. Lead 58 preferably includes a lower end thereof, such as in non-conductive segment 59 to allow switch member 52 to extend therethrough and contact contact member 42. At or above the activating temperature, switch member 52 deforms and breaks the circuit between conductive terminal 24 and contact member 42, drawing a conductive portion of lead 58 away from conductive terminal 24 as shown by the dashed lines in FIG. 4.

FIG. 5 is similar to FIG. 1 and illustrates a current interrupting switch 50 disposed between contact member 42 and cover contact 56 electrically connected to conductive terminal 24. Conductive terminal 24 is a conductive protrusion, preferably metal, which includes a lower flange isolated from seal plate 44 by gasket 46. It is to be understood that gasket 46 in a further embodiment is absent when seal plate 44 is non-conductive whereby conductive terminal 24 can be directly in contact with seal plate 44. End assembly 20 also includes terminal cap 22 which extends around and over the lower flange of conductive terminal 24 with the outer peripheral edge of terminal cap 22 connected to container 12, such as under a crimped end thereof. As illustrated in FIG. 5, terminal cap 22 is a non-conductive material and, therefore, can be in direct contact with container 12. In one embodiment, conductive terminal 24 is press fitted into terminal cap 22 prior to incorporation in cell 10. The switch assembly can be preassembled in the end assembly prior to incorporation into cell 10.

A further embodiment of an electrochemical cell 110, including a current interrupting switch 150 is illustrated in FIG. 6. The embodiment is free of a seal plate between the electrode assembly 130 and the end assembly 120 and preferably uses a terminal cap 122 and a gasket 116 to seal the cell, thereby creating additional room in the cell 110 for active materials. Moreover, the sealing surface between the container 112 and end assembly 120 is present outside the container 112, with a portion of the end assembly 120, preferably the terminal cap 122 crimped over and around the periphery of top end 114 of container 112. While a single layer container top end 114 can be crimped together with gasket 116 and terminal cap 122 of end assembly 120, desirably top end 114 is a refold-type end wherein the end of the container is folded back upon itself, preferably outwardly, along a length thereof. The refold end is produced utilizing standard metal-working equipment as known in the art. The refold end can increase the crimp release strength between the end assembly 120 and container 112.

As illustrated in FIG. 6, electrode assembly 130 is located in a lower portion of cell 110, such as described hereinabove with respect to electrode assembly 30. An insulating member 146 is located around the peripheral portion of the top of the electrode assembly 130 to prevent the positive electrode current collector 134 and various portions of current interrupting switch 150 from making contact with the container 112. In one embodiment, insulating member 146 is cone-shaped and serves as a guide for switch member 152 of the current interrupting switch 150. Insulating member 146, as illustrated in FIG. 6, has a narrow upper portion with an outer surface abutted against the inward crimped portion of container upper end 114. Insulating member 146 preferably includes a seat 147 as shown in FIG. 6 which matingly engages a lower portion of switch member 152 and serves to align and maintain the switch member at a desired location and also allow for desired switch member 150 movement. In an alternative embodiment, insulating member 146 is a tube, fitting around at least a part of the electrode assembly and the switch 150, thereby insulating container from contact with current interrupting switch 150 and current collectors 134. Any suitable insulating material can be used for insulating member 146, such as a polymeric or elastomeric material.

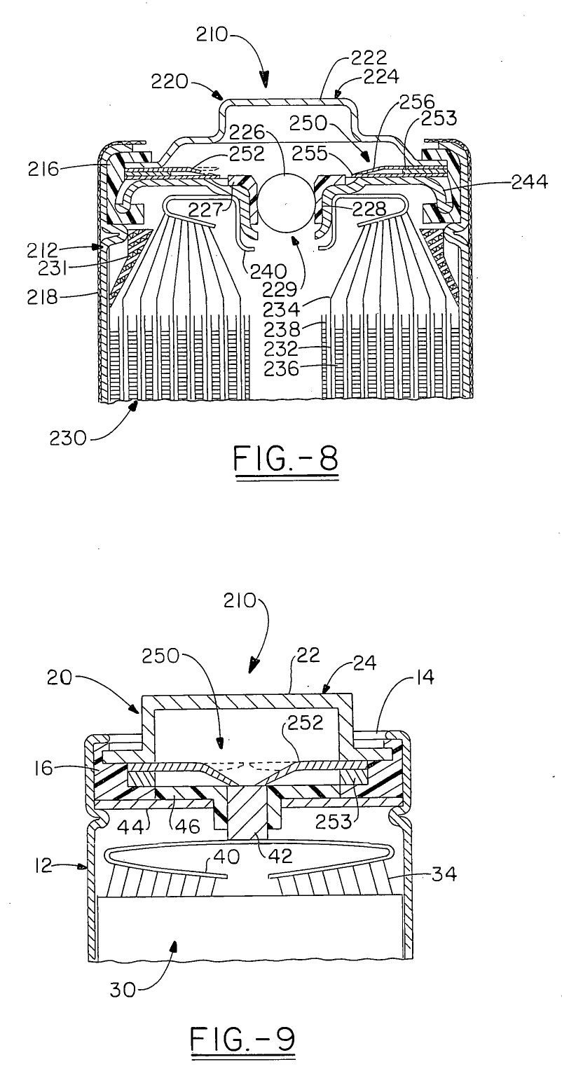

Switch member 152 is generally cone-shaped and provides an electrical path between positive electrode 132 through current collector 134 and conductive terminal 124 of end assembly 120 below an activating temperature of switch member 152. Switch member 152 includes a base 154 generally in contact with gasket 146 and one or more arms 156 having a portion adapted to selectively contact conductive terminal 124 directly or indirectly through an additional conductive member. As with switch member 52, switch member 152 can be formed including a bimetal and/or shape memory alloy which, at or above the activating temperature deforms, whereby arms 156 move downward and disconnect from conductive terminal 124 thereby breaking or interrupting an electrical circuit within the cell 110. Preferably, switch member 152 is designed to revert to its normal form when the temperature thereof or internal portion of the cell decreases below the activating temperature. A top view of the switch member 152 is illustrated in FIG. 7. In the embodiment illustrated, the switch member 152 includes four arms 156 extending inwardly and upwardly from base 154.

Advantageously, the gasket 146 and current interrupting switch 150 can be joined to form a sub-assembly prior to use in the cell, and can be inserted into the container 112 after insertion of the electrode assembly 130. The container 112 is necked inward at a portion of top end 114. Afterwards, the end assembly 120, including terminal cap 122 and gasket 116, is placed on the top of open end of container 112 and the edge of terminal cap 122 and gasket 116 are crimped inward and preferably downward to seal the cell. A suitable relief vent mechanism, such as a rupture membrane, a coined vent or ball vent, as known to those of ordinary skill in the art, can be built either into the container 112 or into the end assembly 120.

Advantages of the embodiment, such as shown in FIG. 6, include eliminating numerous parts in conventional use including a header assembly, seal plate, etc. Sealing capability is improved as a single sealing surface is provided, with sealing surface area being relatively small and disposed outside of the container. The current interrupting switch 150 has a relatively large surface contact area with current collector 134 of the positive electrode and maintains good electrical contact therewith. A label 118 is shown present around the outside perimeter of container 112.

An additional embodiment of an electrochemical cell 210, including a current interrupting switch 250, is shown in FIG. 8. Current interrupting switch 250 includes a switch member 252 which can be formed from the same materials as described herein for switch members 52 and 152, for example a shape memory alloy or bimetal material. In one embodiment, switch member 252 is washer-shaped and includes inwardly extending arms 256 adapted to contact conductive member 255, when present, below the activating temperature of the switch member. Otherwise arms 256 can contact seal plate 244 directly in another embodiment. At or above the activating or predetermined temperature, switch member 252 deforms, whereby arms 256 move upward and disconnect or otherwise break contact with conductive member 255, thereby discontinuing the electrical path or circuit within cell 210, namely between conductive member 255 and conductive terminal 224 of terminal cap 222. Preferably, switch member 252 is designed to return to its predisposed form when the temperature thereof decreases below the activating temperature. Generally any number of arms can be utilized, with two shown in FIG. 8. The number of arms is chosen such that in a normal position, current flow between conductive member 255 through switch member 252 to conductive terminal 224 is sufficient and without too great a resistance.

Insulating member 253 is preferably shaped as a washer or torus that is adhered to switch member 252 or otherwise separates the switch member 252 from conductive member 255 or seal plate 244 other than at contact through an activatable portion of switch member 252, for example arm 256, which is adapted to break contact with conductive member 255 at or above the activating temperature as described. Generally any non-conductive material can be utilized for insulating member 253, such as a polymer, for example a polyolefin such as polyethylene or propylene or other thermoplastic resin, for example polyphenylene sulfide and polyphthalamide, or a non-conductive adhesive, for example EPDM, or a combination thereof. The material chosen for insulating material 253 should be deformation resistant and substantially unsusceptible to cold flow at high temperatures, for example 75° C. and above, and chemically stable and resistant to degradation in the cell. Bimetal materials and shape memory alloys can be sensitive to pressure and it is desirable that the fit between switch member 252 and insulating member 253 minimizes crimping or deformation of the switch member 252 that could prevent proper intended function thereof. Conductive member 255 can be any suitable material sufficiently conductive as desired within the cell. In one embodiment, a metal foil is utilized which is preferably adhered to the insulating member 253. Examples of suitable metal foils include, but are not limited to, nickel, copper, nickel-plated copper, and nickel-plated steel. If desired, one or more appropriate adhesives can be utilized to attach one or more of the switch member 252, insulating member 253 and conductive member 255.

As illustrated in FIG. 8, cell 210 has a housing that includes container 212, an electrode assembly including positive electrode 232, negative electrode 236, separated by a separator 238, with positive electrode 232 including one or more metal current collectors 234. Container 212 is closed within internal cell cover or sealing plate 244 and a gasket 216. Container 212 has a reduced diameter step in the top end that supports gasket 216 and sealing plate 244. Gasket 216 is compressed between container 212 and sealing plate 244 to seal the electrode assembly within the container. The electrode assembly illustrated is a spirally wound, jelly-roll electrode assembly. Metal current collectors 234 extend from the top end of the electrode assembly and are connected to the inner surface of sealing plate 244 by a contact spring 240. The negative electrode 236 is electrically connected to the inner surface of the container 212 preferably by a metal lead (not shown). An insulating member shown as a cone 231 is located around the peripheral portion of the top of the electrode assembly to prevent the positive electrode current collector 234 from making contact with the container 212. Terminal cap 222 is held in place by the ordinarily crimped top edge of the container 212 and gasket 216. Terminal cap 222 has one or more vent apertures (not shown). In the embodiment illustrated, container 212 serves as a negative contact terminal. An insulating jacket, namely label 218 is shown attached to portions of the outside of container 212. The current interrupting switch 250 is disposed between the peripheral flange of terminal cap 22 and sealing plate 244. Cell 210 also includes a pressure relief vent. The cell sealing plate 244 includes an aperture comprising an inwardly projecting central vent well 228 with a vent hole 229 in the bottom of the well 228. The aperture is sealed by a vent ball 226 and a thin-walled thermoplastic bushing 227 which is compressed between the vertical wall of the vent well 228 and the periphery of the vent ball 226. When the cell internal pressure exceeds a predetermined level, the vent ball 226 or both ball 226 and bushing 227, is/are forced out of the aperture to release pressurized gasses from the cell 210.

An advantage of the current interrupting switch 250, as illustrated in FIG. 8, is that the same can be preassembled comprising switch member 252, insulating member 253, and optionally conductive member 255 as desired and added to the cell prior to final crimping of container 212. Moreover, in one embodiment, the end assembly comprising terminal cap 222, current interrupting switch 250, cell cover 244 and gasket 216 can be preassembled as a unitary construction thereby further facilitating ease of processing.

A further embodiment of current interrupting switch 250 is illustrated in FIG. 9. The cell construction is similar to the construction as shown in FIG. 1, wherein current interrupting switch 50 has been replaced with current interrupting switch 250. Current interrupting switch 250 includes switch member 252 and insulating member 253. In a normal operating position, switch member 252 is in electrical contact with contact member 42, via an arm thereof, and also in contact with conductive terminal 24 directly as shown, or otherwise through another conductive member (not shown). At or above the activating temperature, switch member 252 deforms away from contact member 42 thereby breaking the internal circuit or path between a cell electrode and the conductive terminal 24, see dashed lines.

In the arrangements shown in FIGS. 1 through 6, 8 and 9, conductive terminal 24, 124, 224 is the positive cell terminal while the container 12, 112, 212 is the negative terminal. However, it will be recognized by those of ordinary skill in the art that reverse arrangements are possible and either the positive or negative electrode may be connected to the container 12, 112, 212 while the opposite electrode is connected operatively to the conductive terminal 24, 124, 224.

The cell container is often a metal can with an integral closed bottom, although a metal plate can be fastened to one end of a metal tube to provide a container with a closed bottom. The container is generally steel, plated with nickel on at least the outside to protect the outside of the can from corrosion. The type of plating can be varied to provide varying degrees of corrosion resistance or to provide the desired appearance. The type of steel will depend in part on the manner in which the container is formed. For drawn cans, the steel can be a diffusion annealed, low carbon, aluminum killed, SAE 1006 or equivalent steel, with a grain size of ASTM 9 to 11 and equiaxed to slightly elongated grain shape. Other steels, such as stainless steels, can be used to meet special needs. For example, when the can is in electrical contact with the cathode, a stainless steel may be used for improved resistance to corrosion by the cathode and electrolyte.

The terminal cap should have good resistance to corrosion by water in the ambient environment, include a conductive terminal with good electrical conductivity and, when visible on consumer batteries, an attractive appearance. Conductive portions of terminal covers are often made from nickel plated cold rolled steel or steel that is nickel plated after the covers are formed. A non-conductive portion of a terminal cap can be any suitable thermoplastic material, such as polypropylene and polyethylene. Where terminals are located over pressure relief vents, the terminal cap generally has one or more holes to facilitate cell venting.

The one or more gaskets or insulating members of the electrochemical cells of the invention individually comprise a thermoplastic material that is resistant to cold flow at high temperatures (e.g., 75° C. and above), chemically stable (resistant to degradation, e.g., by dissolving or cracking) when exposed to the internal environment of the cell and resistant to the transmission of air gases into and electrolyte vapors from the cell. Gaskets can be made from thermoplastic resins. Resins used to make gaskets for nonaqueous cells can comprise polyphenylene sulfide and polyphthalamide and combinations thereof as base resins. The base resin can be blended with modifiers to provide the desired gasket properties. Small amounts of other polymers, reinforcing organic fillers and/or organic compounds may also be added to the base resin of the gasket. A preferred base resin is polyphthalamide. In one embodiment, polyphthalamide can be used alone. An example of a suitable polyphthalamide resin is RTP 4000 from RTP Company of Winona, Minn., USA. In another embodiment, an impact modifier is added to the polyphthalamide. For example, 5 to 40 weight percent of an impact modifier can be added; such a material is available as AMODEL® ET 1001 L from Solvay Advanced Polymers, LLC of Alpharetta, Ga., USA. Another preferred base resin is polyphenylene sulfide, to which from greater than 10 to no greater than 40, preferably from greater than 10 to no greater than 30, and more preferably at least 15 weight percent of an impact modifier is added; such a material is available as FORTRON® SKX 382 from Ticona-US of Summit, N.J., USA. To improve the seal at the interfaces between the gasket and other cell components, the gasket can be coated with a suitable sealant material. A polymeric material such as EPDM can be used in embodiments with an organic electrolyte solvent.

The negative electrode or anode of an FR6 type cell contains lithium metal, typically in the form of a sheet or foil strip. The composition of the lithium can vary, though the purity is always high. The lithium can be alloyed with other metals, such as aluminum, to provide the desired cell electrical performance. A preferred lithium alloy is a battery grade lithium-aluminum alloy comprising about 0.5 weight percent aluminum, available from Chemetall Foote Corp. of Kings Mountain, N.C., USA. When the negative electrode or anode is a solid piece of lithium, a separate current collector within the anode is generally not used, since the lithium metal has a very high electrical conductivity. However, a separate current collector can be used to provide electrical contact to more of the remaining lithium toward the end of cell discharge. Copper is often used because of its conductivity, but other conductive metals can be used as long as they are stable inside the cell. A conductive metal strip, such as but not limited to a thin strip of nickel, nickel plated steel, copper or a copper alloy, can be used to make electrical contact between the lithium anode and the container. This strip can be pressed into the surface of the lithium foil. The strip can be welded to the inside surface of the container, or it can be held firmly against the container to provide a pressure contact. Because lithium and lithium alloy metals are typically highly conductive, a separate current collector within the negative electrode or anode is often unnecessary in lithium and lithium alloy anodes.

The positive electrode or cathode of an FR6 type cell contains iron disulfide as an active material. A preferred iron disulfide is a battery grade FeS₂ having a purity level of at least 95 weight percent, available from American Minerals, Inc. of Camden, N.J., USA; Chemetall GmbH of Vienna, Austria; Washington Mills of North Grafton, Mass., USA; and Kyanite Mining Corp. of Dillwyn, Va., USA. The FeS₂ can be milled and sieved to achieve the desired particle size distribution and remove large particles that could puncture the separator in the cell. The largest particles should be smaller than the thinnest coating of cathode material on the current collector. Preferably the average particle size is no greater than about 30 μm, and more preferably less than about 20 μm. In addition, the positive electrode or cathode often contains one or more conductive materials such as metal, graphite and carbon black powders. Examples of suitable conductive materials include KS-6 and TIMREX® MX15 grades synthetic graphite from Timcal America of Westlake, Ohio, USA, and grade C55 acetylene black from Chevron Phillips Company LP of Houston, Tex., USA. A binder may be used to hold the particulate materials together. Ethylene/propylene copolymer (PEPP) made by Polymont Plastics Corp. of Akron, Ohio, USA, and G1651 grade styrene-ethylene/butylene-styrene (SEBS) block copolymer from Kraton Polymers of Houston, Tex., USA, are suitable for use as a binder. Small amounts of various additives may also be used to enhance processing and cell performance. Examples include POLYOX®, a nonionic water soluble polyethylene oxide from Dow Chemical Company of Midland, Mich., USA, FLUO HT® micronized polytetrafluoroethylene (PTFE) manufactured by Micro Powders Inc. of Tarrytown, N.Y., USA (commercially available from Dar-Tech Inc. of Cleveland, Ohio, USA), and AEROSIL® 200 grade fumed silica from Degassa Corporation Pigment Group of Ridgefield, N.J., USA.

A positive electrode or cathode current collector may be required. Aluminum foil is a commonly used material. A mixture of the positive electrode or cathode materials in a solvent can be coated onto the aluminum foil using a suitable process, such as a roll coating process, followed by evaporation of the solvent. The coated aluminum foil can then be densified, by calendering, for example, and can also be dried prior to use.

The contact spring can be made of a conductive metal with low resistivity, such as nickel plated stainless steel, that is chemically stable in the cell internal environment. It should also have good spring characteristics. Preferably the spring force constant (stiffness) will be sufficient for the spring to apply at least a minimum amount of force against the positive electrode current collector, contact member, or other cell components. The spring can be affixed to the contact member in any suitable manner that will maintain good electrical contact. For example, the contact spring can be welded to a lower surface of the contact member and may provide lower internal resistance.

Any suitable separator material may be used. Suitable separator materials are ion-permeable and electrically nonconductive. They are generally capable of holding at least some electrolyte within the pores of the separator. Suitable separator materials are also strong enough to withstand cell manufacturing and pressure that may be exerted on them during cell discharge without tears, splits, holes or other gaps developing. Examples of suitable separators include microporous membranes made from materials such as polypropylene, polyethylene and ultrahigh molecular weight polyethylene. Preferred separator materials for Li/FeS₂ cells include CELGARD® 2400 microporous polypropylene membrane from Celgard Inc. of Charlotte, N.C., USA, and Tonen Chemical Corp.'s Setella F20DHI microporous polyethylene membrane, available from Exxon Mobil Chemical Co. of Macedonia, N.Y., USA. A layer of solid electrolyte or a polymer electrolyte can also be used as a separator.

Electrolytes for lithium and lithium ion cells are nonaqueous electrolytes. In other words, they contain water only in very small quantities (e.g., no more than about 500 parts per million by weight, depending on the electrolyte salt being used) as a contaminant. Suitable nonaqueous electrolytes contain one or more electrolyte salts dissolved in an organic solvent. Any suitable salt may be used, depending on the anode and cathode active materials and the desired cell performance. Examples include lithium bromide, lithium perchlorate, lithium hexafluorophosphate, potassium hexafluoro-phosphate, lithium hexafluoroarsenate, lithium trifluoromethanesulfonate and lithium iodide. Suitable organic solvents include one or more of the following: dimethyl carbonate, diethyl carbonate, methylethyl carbonate, ethylene carbonate, propylene carbonate, 1,2-butylene carbonate, 2,3-butylene carbonate, methyl formate, γ-butyro-lactone, sulfolane, acetonitrile, 3,5-dimethylisoxazole, n,n-dimethyl formamide and ethers. The salt/solvent combination will provide sufficient electrolytic and electrical conductivity to meet the cell discharge requirements over the desired temperature range. While the electrical conductivity is relatively high compared to some other common solvents, ethers are often desirable because of their generally low viscosity, good wetting capability, good low temperature discharge performance and good high rate discharge performance. This is particularly true in Li/FeS₂ cells because the ethers are more stable than with MnO₂ cathodes, so higher ether levels can be used. Suitable ethers include, but are not limited to, acrylic ethers such as 1,2-dimethoxyethane, 1,2-diethoxyethane, di(methoxyethyl)ether, triglyme, tetraglyme and diethyl ether; and cyclic ethers such as 1,3-dioxolane, tetra-hydrofuran, 2-methyl tetrahydrofuran and 3-methyl-2-oxazolidinone.

Specific anode, cathode and electrolyte compositions and amounts can be adjusted to provide the desired cell manufacturing performance and storage characteristics, as disclosed, for example, in U.S. Patent Publication No. 2005/0112462 A1, which is incorporated herein by reference.

The cell can be closed and sealed using any suitable process. Such processes may include, but are not limited to, crimping, redrawing, colleting and combinations thereof.

The above description is particularly relevant to FR6 type cells, examples of which are disclosed in further detail in U.S. Patent Publication Nos. 2005/0079413 A1 and 2005/0233214 A1 , which are incorporated herein by reference. However, the invention may also be adapted to other cell sizes (e.g., FR03 and FR8D425) and other types of cells, such as non-cylindrical (e.g., prismatic) cells, cells with other pressure relief vent designs, and cells having other electrochemical systems.

Batteries according to the invention can be primary or rechargeable batteries. The cells they contain can be lithium cells, lithium ion cells, or aqueous alkaline cells. The invention is particularly useful in lithium batteries because of a complete interruption of the internal circuit and a runaway exothermic reaction in the cell. Examples of other lithium cells include Li/CuO, Li/CuS, Li/FeS, Li/MnO₂, and Li/MoS₂. Li/FeS₂ and Li/FeS batteries are especially preferred because the reduction in internal resistance made possible by the elimination of a PTC is more critical in lower voltage cells.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

What is claimed is:

1. An electrochemical cell, comprising:
a container having a closed end and an open end;
an electrode assembly disposed within the container and including a negative electrode, a positive electrode, an electrolyte, and a separator disposed between the negative electrode and positive electrode, wherein one of the electrodes is electrically connected to the container;
an internal seal plate located inside the container and providing a seal between the open end of the container and the electrode assembly, the seal plate being in contact with the container and being electrically non-conductive or having a polarity the same as the container;
an electrically conductive contact member extending through the seal plate; and
an end assembly covering the seal plate and having a terminal cap with a conductive terminal, wherein the contact member provides a portion of an electrical path between the electrode not electrically connected to the container and the conductive terminal, wherein an insulating gasket is present between the seal plate and the contact member when the seal plate is the same polarity as the container, wherein a temperature responsive current interrupting switch is present in the end assembly and operatively connected between the contact member and the conductive terminal so that below an activating temperature the current interrupting switch is at least part of an electrical path between the contact member and the conductive terminal, and at or above the activating temperature the current interrupting switch is out of electrical contact with one or more of the contact member and conductive terminal, and a circuit between the contact member and conductive terminal is opened, and wherein the current interrupting switch is capable of re-establishing a closed circuit between the contact member and conductive terminal when the temperature in the cell is below the activating temperature.

2. The electrochemical cell according to claim 1, wherein the current interrupting switch includes a switch member that comprises one or more of a shape memory alloy and a bimetal.

3. The electrochemical cell according to claim 2, wherein the switch member is a spring having a first end connected to either the contact member or the conductive terminal and a second end disposed in contact with the contact member or conductive terminal not connected to the first end of the spring and capable of moving out of electrical contact therewith at or above the activating temperature.

4. The electrochemical cell according to claim 3, wherein a non-conductive guide rod extends between the conductive terminal and the contact member, and wherein the non-conductive guide rod is disposed within the spring and is a guide for the spring.

5. The electrochemical cell according to claim 2, wherein the switch member has a first end portion fixedly connected to either the contact member or the conductive terminal and a second end disposed against the contact member or conductive terminal that is not fixedly connected to the first end below the activating temperature and capable of breaking contact with the contact member or conductive terminal at or above the activating temperature.

6. The electrochemical cell according to claim 5, wherein the switch member first end is connected to the contact member and the second end below the activating temperature is in contact with an underside of the conductive terminal or a side of the conductive terminal.

7. The electrochemical cell according to claim 2, wherein the switch member is a spring, wherein a first end of the spring is connected to the contact member and a second end of the spring is connected to a conductive portion of a lead, wherein the conductive portion of the lead is in contact with the conductive terminal below the activating temperature and is out of electrical contact at or above the activating temperature due to movement of the switch member, and wherein a non-conductive portion of the lead is connected to either (a) the contact member, (b) the insulating gasket between the contact member and the seal plate or (c) the seal plate, or combinations thereof.

8. The electrochemical cell according to claim 1, wherein the terminal cap has a portion that is non-conductive and having a periphery in contact with a portion of the container, and wherein the conductive terminal is a substantially cylindrical protrusion which extends outwardly from a central portion of the terminal cap.

9. The electrochemical cell according to claim 2, wherein the conductive terminal includes a conductive cover contact connected to an inner surface of the terminal cap, and wherein below the activating temperature the switch member is in contact with the cover contact and the contact member and at or above the activating temperature the switch member is out of electrical contact with one or more of the cover contact and contact member.

10. The electrochemical cell according to claim 2, wherein the switch member is a disk having a periphery in contact with the conductive terminal and one or more arms in contact with the contact member below the activating temperature and which are capable of breaking contact with the contact member at or above the activating temperature.

11. The electrochemical cell according to claim 10, wherein an insulating washer having an aperture is present between the seal plate and the disk, and wherein the one or more disk arms extend through the aperture and contact the contact member below the activating temperature.

12. The electrochemical cell according to claim 2, wherein the container is a cylindrical container, wherein the electrode assembly is a jelly-roll electrode assembly, and wherein the negative electrode comprises lithium.

13. The electrochemical cell according to claim 12, wherein the positive electrode is operatively electrically connected to the conductive terminal and the negative electrode is electrically connected to the container, wherein the positive electrode includes a current collector, wherein a contact spring is connected to the contact member, and wherein one or more of the positive electrode current collectors are in contact with the contact spring.

14. The electrochemical cell according to claim 12, wherein the activating temperature is from about 70° C. to about 110° C.

15. The electrochemical cell according to claim 14, wherein the activating temperature is from about 85° C. to about 100° C.

16. The electrochemical cell according to claim 2, wherein the cell includes a pressure relief vent.

17. The electrochemical cell according to claim 16, wherein the pressure relief vent is operatively connected to the seal plate and comprises a ball vent, a coined vent, or a rupture membrane.

18. An electrochemical cell, comprising:
a container having a closed end and an open end;
an electrode assembly disposed within the container and including a negative electrode, a positive electrode, an electrolyte, and a separator disposed between the negative electrode and positive electrode, wherein one of the electrodes is electrically connected to the container; and
an end assembly sealing the open end of the container and having a terminal cap with a conductive terminal, and a temperature responsive current interrupting switch operatively connected between the conductive terminal and the electrode of the electrode assembly not electrically connected to the container so that below an activating temperature the current interrupting switch is part of an electrical path between the terminal and the electrode not electrically connected to the container, and at or above the activating temperature the current interrupting switch is switched and the electrical path is interrupted, wherein the current interrupting switch is capable of re-establishing the electrical path when the temperature in the cell is below the activating temperature, wherein an insulating gasket is provided between the terminal cap and the open end of the container, and wherein the terminal cap extends over the open end of the container and has a perimeter that terminates outside of the container and seals the open end.

19. The electrochemical cell according to claim 18, wherein the current interrupting switch includes a switch member in electrical contact with a current collector of the electrode not electrically connected to the container and a segment including one or more of a shape memory alloy and bimetal that is in contact with a portion of the conductive terminal below the activating temperature and is capable of moving out of contact with the portion of the conductive terminal at or above the activating temperature and opening the circuit and interrupting the electrical path.

20. The electrochemical cell according to claim 19, wherein an insulating material is disposed between the container and the switch member, wherein the insulating material is one or more of a tube and a cone-shaped insulation member.

21. The electrochemical cell according to claim 20, wherein the switch member is cone-shaped and has two or more arms which each contact a portion of the conductive terminal and are non-articulatingly movable away from the conductive terminal at or above the activating temperature.

22. The electrochemical cell according to claim 21, wherein the insulating material is a cone-shaped insulation member which includes an annular seat on an inner surface of the member in which a portion of the switch member is positioned.

23. The electrochemical cell according to claim 18, wherein the container is a cylindrical container, wherein the electrode assembly is a jelly-roll electrode assembly, and wherein the negative electrode comprises lithium.

24. The electrochemical cell according to claim 23, wherein the positive electrode includes one or more current collectors, and wherein one or more of the current collectors are in contact with the switch member.

25. The electrochemical cell according to claim 18, wherein the activating temperature is from about 70° C. to about 110° C.

26. The electrochemical cell according to claim 25, wherein the activating temperature is from about 85° C. to about 100° C.

27. The electrochemical cell according to claim 22, wherein the container is a cylindrical container, wherein the electrode assembly is a jelly-roll electrode assembly, and wherein the negative electrode comprises lithium.

28. An electrochemical cell, comprising:
a cylindrical container having a closed end and an open end;
a jelly-roll electrode assembly disposed within the container and including a negative electrode, a positive electrode, an electrolyte, and a separator disposed between the negative electrode and positive electrode, wherein one of the electrodes is electrically connected to the container;
an end assembly having a conductive terminal and a non-articulating temperature-responsive switch, wherein the switch changes shape to selectively control current flow between the electrode not electrically connected to the container and the conductive terminal based upon a pre-determined temperature; and
an internal seal plate and optionally a gasket providing a seal between the open end of the container and the electrode assembly, and wherein the switch is operatively located between the conductive terminal and the seal member within the cell.

29. The electrochemical cell according to claim 28, wherein the switch includes a switch member comprises one of more of a shape memory alloy and a bimetal.

30. The electrochemical cell according to claim 29, wherein a contact member extends through the seal plate to form an electrical connection between the switch and the electrode not electrically connected to the container of the electrode assembly below the predetermined temperature.

31. The electrochemical cell according to claim 30, wherein an insulating gasket is positioned between the seal plate and the contact member.

32. The electrochemical cell according to claim 30, wherein the predetermined temperature is from about 70° C. to about 110° C.,

33. The electrochemical cell according to claim 32, wherein the predetermined temperature is from about 85° C. to about 100° C.

34. The electrochemical cell according to claim 30, wherein the switch has a first end portion fixedly connected to either the contact member or the conductive terminal and a second end disposed against the contact member or conductive terminal that is not fixedly connected to the first end below the predetermined temperature and capable of breaking contact with the contact member or conductive terminal at or above the predetermined temperature.

35. The electrochemical cell according to claim 30, wherein the switch member is a spring, wherein a first end of the spring is connected to the contact member and a second end of the spring is connected to a conductive portion of a lead, wherein the conductive portion of the lead is in contact with the conductive terminal below the predetermined temperature and is out of electrical contact at or above the predetermined temperature due to movement of the switch member, and wherein a non-conductive portion of the lead is connected to either (a) the contact member, (b) the insulating gasket between the contact member and the seal plate or (c) the seal plate, or combinations thereof.

36. The electrochemical cell according to claim 30, wherein the switch member is a disk having a periphery in contact with the conductive terminal and one or more arms in contact with the contact member below the predetermined temperature and which are capable of breaking contact with the contact member at or above the predetermined temperature.

37. The electrochemical cell according to claim 35, wherein an insulating washer having an aperture is present between the seal plate and the disk, and wherein one or more arms extend through the aperture and contact the contact member below the predetermined temperature.

38. The electrochemical cell according to claim 30, wherein the negative electrode comprises lithium, wherein the positive electrode is operatively connected to the conductive terminal and the negative electrode is electrically connected to the container, wherein the positive electrode includes a current collector, wherein a contact spring is connected to the contact member, and wherein one or more of the positive electrode current collectors are in contact with the contact spring.

39. The electrochemical cell according to claim 36, wherein the activating temperature is from about 70° C. to about 110° C.

40. The electrochemical cell according to claim 39, wherein the activating temperature is from about 85° C. to about 100° C.

41. The electrochemical cell according to claim 28, wherein the cell includes a pressure relief vent.

42. The electrochemical cell according to claim 41, wherein the pressure relief vent is operatively connected to the seal plate and comprises a ball vent, a coined vent, or a rupture membrane.

43. The electrochemical cell according to claim 28, wherein at or above the predetermined temperature the switch is switched and an electrical path is opened, whereby current cannot flow between the electrode not electrically connected to the container and the conductive terminal, wherein the switch is capable of re-establishing the electrical path when the temperature of the switch returns below the predetermined temperature.

44. The electrochemical cell according to claim 29, wherein the seal plate and gasket provide a seal between the open end of the container and the electrode assembly, wherein the seal plate has the same polarity as the switch member.

45. The electrochemical cell according to claim 44, wherein the switch member comprises is a disk in contact with the conductive terminal and one or more arms in contact with the seal plate below the predetermined temperature and which are capable of breaking contact with the seal plate at or above the predetermined temperature.

46. The electrochemical cell according to claim 45, wherein an insulating washer having an aperture is present between the seal plate and the disk, and wherein one or more arms of the disk extend through the aperture and contact the seal plate below the predetermined temperature.

47. The electrochemical cell according to claim 45, wherein a spring contact is connected to the seal plate and one or more current collectors of the electrode not electrically connected to the contact spring.

48. The electrochemical cell according to claim 46, wherein the cell includes a ball vent.
